(19) United States
(12) Patent Application Publication
(10) Pub. No.: US 2008/0289913 A1
(43) Pub. Date: Nov. 27, 2008

(54) Self-Amplifying Electromechanical Friction Brake

(76) Inventor: Dietmar Baumann, Hemmingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/096,086

(22) PCT Filed: Mar. 26, 2007
(86) PCT No.: PCT/EP07/52861

§ 371 Date: Jun. 4, 2008

(30) Foreign Application Priority Data
Mar. 28, 2006 (DE) 10-2006-014-250.0

(51) Int. Cl. F16D 55/224

(52) U.S. Cl. 188/72.2

(57) ABSTRACT

The present invention relates to an electromechanical disk brake (1), having a self-amplifying device (10) equipped with a wedge mechanism. According to the present invention, the disk brake (1) is embodied with a lockable, automatically releasing support (17) for a friction brake lining (4). It is thus possible to provide a self-locking design for the disk brake (1) with a negative brake coefficient C* because in the event of a malfunction, it is possible to release the disk brake (1) by releasing the support (17). This enables a powerful self-amplification, as a result of which the disk brake (1) requires little braking force and braking energy.

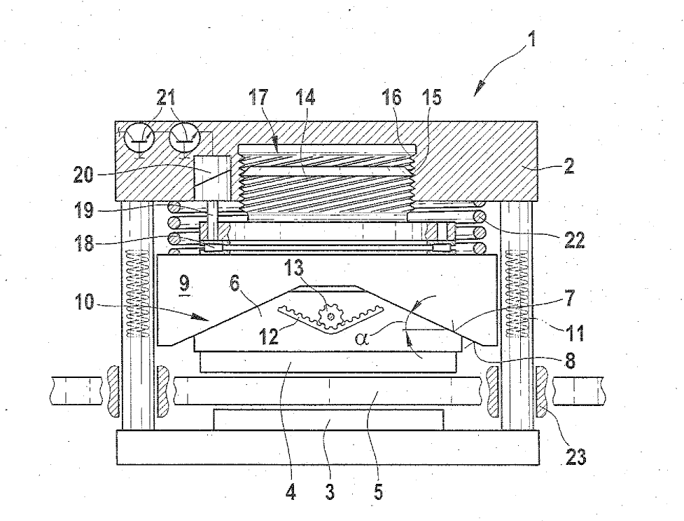

### PRIOR ART

The invention relates to a self-amplifying electromechanical friction brake with the defining characteristics of the preamble to claim 1.

A friction brake of this kind in the form of a disk brake is known from WO 02/40 887 A1. The known friction brake is provided as a vehicle brake for braking a vehicle wheel. It has an electromechanical actuation device, which, in order to actuate friction brake, is able to press a friction brake lining against a brake disk, consequently braking the latter. The brake disk can be referred to generally as a brake body; in the case of a drum brake, the brake body is a brake drum. The electromechanical actuation device of the known friction brake has an electric motor and a screw transmission embodied in the form of a ball screw drive that converts the rotating motion of the electric motor into a translating motion in order to press the friction brake lining against the brake disk. It is also possible to use other rotation/translation-converting transmissions. It is possible for a speed-reduction mechanism to be connected between the electric motor and the rotation/translation-converting transmission. Linear drives, which are equipped, for example, with an electromagnet or a piezoelectric element, can also be used as an electromechanical actuation device for pressing the function brake lining against the brake disk; such devices render transmissions superfluous.

In order to amplify a braking force, the known friction brake has a self-amplifying device that converts a friction force—which the rotating brake body exerts on the friction brake lining that has been pressed against it for braking purposes—into a pressing force that presses the friction brake lining against the brake body in addition to a pressing force exerted by the actuation device, thus increasing the braking force of the friction brake.

The known self-amplifying device has a wedge mechanism equipped with one or more wedge surfaces that support the friction brake lining inclined at an angle in relation to the brake disk. The friction force, which the rotating brake disk exerts on the friction brake lining that is pressed against it during braking, acts on the friction brake lining in the direction of a narrowing wedge gap between the wedge surface and the brake disk. The support of the friction brake lining on the wedge surface that is inclined in relation to the brake disk produces a supporting force perpendicular to the wedge surface, which has a component perpendicular to the brake disk. This force component perpendicular to the brake disk is the additional pressing force that presses the friction brake lining against the brake disk in addition to the pressing force exerted by the actuation device.

The known friction brake has a double ramp mechanism with wedge surfaces sloping upward in both rotation directions of the brake disk so that the self-amplification is effective in both rotation directions of the brake disk. The wedge angles for the two rotation directions of the brake disk can be equal to each other or different; in the latter case, the self-amplification is also of differing intensity.

Instead of a wedge mechanism, it is also possible to provide a ramp mechanism, which, by contrast with a wedge mechanism, has a changing ramp slope. With a large ramp angle at the beginning of the movement of the friction brake lining, it is possible to achieve a rapid advancing movement of the friction brake lining to the brake disk at the beginning of the brake actuation. A smaller ramp angle at the end of the movement of the friction brake lining results in a powerful self-amplification with a significant braking force. The wedge mechanism is a special instance of a ramp mechanism in which the ramp or wedge has a constant ramp or wedge angle over the course of its surface.

Ramp mechanisms and wedge mechanisms are mechanical self-amplification devices. There are also other known mechanical self-amplification devices that have, for example, a lever mechanism equipped with a lever that extends at an angle in relation to the brake disk, is subjected to tension or pressure, and supports the friction brake lining during braking. A support angle at which the lever supports the friction brake lining in relation to the brake disk corresponds to the wedge or ramp angle. These are mechanical equivalents. Other, for example hydraulic, self-amplifying devices are also known and possible.

### DISCLOSURE OF THE INVENTION

The friction brake lining according to the present invention, with the defining characteristics of claim 1, is equipped with a releasable support for the friction brake lining, which supports the friction brake lining against a reaction force to the pressing force in the unreleased state and yields after a release. The support can support the friction brake lining directly or indirectly; it can, for example, also be situated on a side of the brake disk opposite from the friction brake lining, for example in a brake caliper supported in a floating fashion. If the support is not released, the friction brake lining rests indirectly or directly by means of the support, as is customary, in a brake caliper, for example. If the support is released, then the friction brake lining loses its support and the friction brake is released. An actuation of the friction brake when the support is released is not possible or is only possible to a limited degree.

### ADVANTAGES OF THE INVENTION

The present invention has the advantage that in the event of a failure of the actuation device or even of the energy supply, it is possible to release the friction brake by releasing the support. Depending on the embodiment of the friction brake according to the present invention, it releases automatically in the event of a failure of the energy supply. It is important for the friction brake to be releasable if the friction brake operates in a self-locking fashion even if the self-locking only occurs at a high coefficient of friction. Self-locking of the friction brake occurs when the self-amplification is so great that the braking force when the friction brake is actuated would increase all by itself and lead to a locking of the friction brake if the actuation device did not keep the friction brake lining from doing so. A reduction in the braking force and a release of the friction brake in this case is only possible with the actuation device that acts on the friction brake lining in the releasing direction. By releasing the support, it is possible to avoid a locking of the friction brake, thus allowing the brake to be released even in the event of a failure of the actuation device. This permits an operation and a structural design of the friction brake and of its self-amplifying device at least partially in the self-locking range. This permits a powerful self-amplification, as a result of which an actuating force and actuating energy are low. In addition to the reduced energy requirement, this has the advantage of permitting a comparatively lightweight and small actuation device to be used.

Advantageous embodiments and modifications of the invention disclosed in claim 1 are the subject of the dependent claims.

### BRIEF DESCRIPTION OF THE DRAWING

The present invention will be explained in greater detail below in conjunction with an exemplary embodiment shown in the drawing. The sole FIGURE shows a friction brake according to the present invention. The drawing is understood to be a schematic, simplified representation provided for explanation of the invention.

### EMBODIMENT OF THE INVENTION

The friction brake according to the present invention shown in the drawing is a disk brake 1 equipped with a brake caliper 2 in which two friction brake linings 3, 4 are situated on both sides of a brake disk 5. One of the two friction brake linings 3 is situated in the brake caliper 2 in stationary fashion and is referred to below as the stationary friction brake lining 3. The other friction brake lining 4 has a wedge body 6 on a back side oriented away from the brake disk 5. The wedge body 6 has two wedge surfaces 7 on its back side oriented away from the brake disk 5, which are inclined in opposite directions. By means of the wedge surfaces 7, the friction brake lining 4 is supported on corresponding inclined surfaces 8 of a buttress 9. The wedge surfaces 7 and the inclined surfaces 8 axe inclined at a wedge angle α in relation to the brake disk 5. The friction brake lining 4 is guided in sliding fashion along the inclined surfaces 8, i.e. the friction brake lining 4 can move along an imaginary helical path in the wedge angle α in relation to the brake disk 5, where an imaginary axis of the helical path coincides with a rotation axis of the brake disk 5. For actuation, the friction brake lining 4 is slid in the rotation direction of the brake disk 5 and in the process, is supported on one of the two inclined surfaces 8. In the opposite rotation direction of the brake disk 5, the friction brake lining 4 is supported on the other inclined surface 8. The wedge angle α of the two wedge surfaces 7 and inclined surfaces 8 can be the same or different.

In order to actuate the disk brake 1, the friction brake lining 4 is slid as mentioned above, along one of the two inclined surfaces 8 so that it comes into contact with the brake disk 5. It is slid further, causing the brake caliper 2 to slide perpendicular to the brake disk 5 so that the stationary friction brake lining 3 on the opposite side is also pressed against the brake disk 5, thus braking it. The brake caliper 2 is able to slide perpendicular to the brake disk 5 in symbolically depicted bearings 23; this is also referred to as floating support. The two friction brake linings 3, 4 that are pressed against the brake disk 5 brake the brake disk 5. The rotating brake disk 5 exerts a friction force on the friction brake linings 3, 4 that are pressed against it, which acts on the sliding friction brake lining 4, referred to below as the mobile friction brake lining, in the direction of a narrowing wedge gap between the inclined surface 8 and the brake disk 5. The support of the friction brake lining 4 by means of its wedge body 6 against the inclined surface 8 produces a supporting force that has a component perpendicular to the brake disk 5. This force component perpendicular to the brake disk 5 presses the friction brake lining 4 against the brake disk 5 in addition to a pressing force exerted by an actuation device that will be explained in greater detail below, thus increasing the braking force. The wedge body 6 with the wedge surfaces 7 and the buttress 9 with the inclined surfaces 8 combine to form a self-amplifying device 10 of the disk brake 1, which converts a friction force—which the rotating brake disk 5 exerts on the mobile friction brake lining 4 during actuation of the disk brake 1—into a pressing force that amplifies the braking force of the disk brake 1. The self-amplifying device 10 has the above-described double wedge mechanism that is effective in both rotation directions of the brake disk 5.

The wedge body 6 can be supported against the inclined surfaces 8 by means of rollers; in the exemplary embodiment shown, it is supported in sliding fashion.

An elasticity of the brake caliper 2 and possibly other parts of the disk brake 1 such as the friction brake lining 3, 4 is indicated by the spring symbols 11 in the drawing.

The actuation device of the disk brake 1 is electromechanical; it has a rack 12 on the wedge body 6 that has two sections, each of which extends parallel to one of the two wedge surfaces 7 and inclined surfaces 8. The rack 12 is bent or curved in the middle. The rack 12 meshes with a gear 13 that is supported in rotating fashion on the brake caliper 2 and can be driven by means of an electric motor, not shown, via a gear speed-reduction mechanism that is likewise not shown. When the gear 13 is driven to rotate, the wedge body 6 and with it, the mobile friction brake lining 4, is slid in the fashion described above, thus actuating the disk brake 1.

A support body 14 that is situated on a back side of the buttress 9 oriented away from the brake disk 5 supports the mobile friction brake lining 4 in the brake caliper 2 by means of the wedge body 6 and the buttress 9. The support body 14 is a rotationally symmetrical part with an external thread 15 that is screwed into an internal thread 16 of the brake caliper 2. A thread pitch is selected to be great enough that the threads 15, 16 are not self-locking. The buttress 9 is supported against the support body 14 by means of an axial conical roller bearing 18 so that the support body 14 can be easily rotated. The support body 14 constitutes a support 17 for the mobile friction brake lining 4, which is embodied as automatically releasing due to the fact that the threads 15, 16 are not self-locking. A locking pin 19 that engages in a bore in the outer region of the support body 14 holds the support body 14 in a rotationally fixed fashion so that it supports the mobile friction brake lining 4 in the brake caliper 2 during an actuation of the disk brake 1. The locking pin 19 is held in the bore of the support body 14 by an electromagnet 20; when the electromagnet 20 is without current, a spring element that is not visible in the drawing pulls the locking pin 19 out of the support body 14 so that the support body 14 can freely rotate and the support 17 is automatically released. The support 17 and with it, the disk brake 1 is thus always releasable, even in the event of a failure of the actuation device 12, 13 of the disk brake 1 or a failure of the energy supply. The electromagnet 20 has two series connected switches, for example transistors 21, in order to assure a release even in the event of a short-circuit of the switch. It is thus possible to prevent an undesired actuation of the electromagnet 20.

A spring element 22 in the form of a helical compression spring is supported in the brake calipers 2 and acts on the buttress 9 in the direction of the brake disk 5. The spring element 22 embodied as a helical compression spring encompasses the support body 14. It produces an automatic advancing movement of the support 17 when the disk brake 1 is not actuated and the support 17 is released by a withdrawal of the locking pin 19. After a release of the support 17 through a withdrawal of the locking pin 19, the support 17 yields, i.e. it no longer supports the mobile friction brake lining 14 against the pressing force on the brake disk 5 so that the disk brake 1 is released.

The support body 14 has holes situated along an imaginary circle for the engagement of the locking pin 19 so that the support body 14 can be immobilized at different short intervals of rotation angle. The engagement of the locking pin 19 in the hole immobilizes the support body 14 in a form-locked fashion. A non-positive, frictionally engaging, and infinitely variable immobilization of the support body 14 (not shown) is also possible.

In order to adjust an air play of the disk brake 1, the support 17 is released by withdrawal of the locking pin 19 from the support body 14 by means of the currentless electromagnet 20. The spring element 22 moves the buttress 9 toward the brake disk 5 so that the friction brake lining 4 rests against the brake disk 5. The actuation device 12, 13 slides the friction brake lining 4 until it reaches a position corresponding to a desired air play, i.e. a gap, between the friction brake lining 4 and the brake disk 5. The friction brake lining 4 can also be slid before a release of the support 17. By supplying current to the electromagnet 20, the support 17 is immobilized and the friction brake lining 4 is slid back into its initial position in which the desired air play is set. This achieves a wear readjustment. The setting of the air play can in principle be carried out while the brake disk 5 is rotating; preferably, it occurs while the brake disk 5 is stationary, i.e. while a vehicle equipped with the disk brake 1 is at rest. For example, the setting of the air gap can be carried out every time an ignition of the vehicle is switched on.

In the embodiment of the disk brake 1 according to the present invention that is depicted and described here, the wedge angle α is selected to be acute so that a self-locking of the disk brake 1 occurs. This is true in any case for a part of the range of the coefficient of friction μ between the friction brake lining 4 and the brake disk 5 that can occur in actual use. Preferably, it is true for the majority or entirety of the range of the coefficient of friction μ because the necessary actuation force and actuation energy of the disk brake 1 is therefore smaller. The disk brake 1 is designed for a negative brake coefficient C* or for a brake coefficient C* in the vicinity of a pole position at which the sign of the brake coefficient C* changes. The brake coefficient C* is the ratio between the circumference force on the brake disk 5 and the actuating force for sliding or holding the mobile friction brake lining 4. During self-locking operation, the self-amplification of the disk brake 1 would allow the braking force to increase until the brake disk 5 locked; once a desired braking force has been reached, the actuation device must keep the friction brake lining 4 from continuing to move with the brake disk 5. In order to reduce the braking force, the actuation device must slide the friction brake lining 4 in the release direction by exerting an actuating force; an increase in the braking force occurs without the exertion of force and without the consumption of energy.

A spring force of the spring element 22 is slight so that the mobile friction brake lining 4 rests against the brake disk 5 with only a slight contact pressure, generating a negligible braking force. A vehicle equipped with the disk brake 1 can be used in the event of a failure of the disk brake 1, even if the spring element 22 is pressing the mobile friction brake lining 4 against the brake disk 5.

1-11. (canceled)

12. A self-amplifying electromechanical friction brake, comprising:
a friction brake lining;
a rotating brake body to be braked;
an actuation device actuating the friction brake to press the rotating brake body against the friction brake lining with a first pressing force;
a self-amplifying device converting a function force exerted by the rotating brake body on the friction brake lining during braking actuated by the actuation device into an additional pressing force that presses the friction brake lining against the brake body in addition to the pressing force exerted by the actuation device; and
a releasable support for the friction brake lining, which supports the friction brake lining against a reaction force to the first pressing force on the brake disk in an unreleased state, and which yields to the first pressing force on the brake disk in a released state.

13. The electromechanical, self-amplifying friction brake according to claim 12, wherein the support is automatically releasing.

14. The electromechanical, self-amplifying friction brake according to claim 12, including means to immobilize the support at various distances from the brake body.

15. The electromechanical, self-amplifying friction brake according to claim 12, wherein the support automatically advances toward the friction bake lining in the released state.

16. The electromechanical, self-amplifying friction brake according to claim 12, wherein the self-amplifying device is designed for a pole position of a brake coefficient C*.

17. The electromechanical, self-amplifying friction brake according to claim 12, wherein the friction brake has a negative brake coefficient C*.

18. The electromechanical, self-amplifying friction brake according to claim 12, wherein the self-amplification device is effective in both rotation directions of the braking body.

19. The electromechanical, self-amplifying friction brake according to claim 12, wherein the friction brake is a disk brake.

20. The electromechanical, self-amplifying friction brake according to claim 12, wherein the self-amplifying device includes a ramp mechanism.

21. The electromechanical, self-amplifying friction brake according to claim 12, wherein the support is redundantly releasable.

22. The electromechanical, self-amplifying friction brake according to claim 15, wherein in order to set an air play between the friction brake lining and the brake body, the actuation device slides the friction brake lining by a distance that corresponds to the desired air gap; the support is released, and, after contact of the friction brake lining against the brake body, is immobilized; and then the actuation device slides the friction brake lining back into its initial position.
